(19) United States
(12) Patent Application Publication
(10) Pub. No.: US 2025/0288912 A1
(43) Pub. Date: Sep. 18, 2025

(54) COMPUTER PLANNING AGENT

(71) Applicant: OXIDE INTERACTIVE, INC., Timonium, MD (US)

(72) Inventors: Will CHAMBERS, Timonium, MD (US); Eric ALZHEIMER, Timonium, MD (US); Leif MYER, Timonium, MD (US)

(21) Appl. No.: 19/079,608

(22) Filed: Mar. 14, 2025

Related U.S. Application Data
(60) Provisional application No. 63/565,389, filed on Mar. 14, 2024.

(51) Int. Cl. A63F 13/822; A63F 13/533

(52) U.S. Cl. CPC A63F 13/822; A63F 13/533; A63F 2300/807

(57) ABSTRACT

A computer-implemented planning agent employing a dictionary of goal, action, and method, refiners to build refiner tree via iteratively relevance binding refiners to distal nodes of the tree, according relevance to the node as defined in the dictionary, then applicability binding those added refiners supported by the current state at that node of the tree. When one or more branches achieve a state in which the top-level goal is achieved, a plan made by choosing the actions along a selected successful branch. The plan can be an unscheduled dependency-ordered sequence of actions, which can be scheduled by atomizing each action into separate sets of start and end conditions and paralleling the atomic action components to the extent permissible by action dependencies.

### CROSS-REFERENCE TO RELATED APPLICATIONS

This application is a continuation of U.S. Provisional Patent Application No. 63/565,389 (Chambers, et al.) Computer Planning Agent, filed Mar. 14, 2024, which is hereby incorporated by reference herein in its entirety.

### TECHNICAL FIELD

The invention relates to artificially intelligent planning agents.

### BACKGROUND

In environments where there are large numbers of potentially beneficial steps to be taken, and/or large numbers of possible sequences of steps, conventional autonomous planning agents often struggle to efficiently determine a plan to achieve goals. Most real-world environments—from warehouses to residential households to theaters of combat, the natural world, and outer space—present highly complex choices due to limited resources, plural actors, tradeoffs, and incomplete information about the state of the world. The range of options, and multitude of ways in which choices may be combined, present potentially tremendous computational challenges to automated planning. The same is true in many simulated environments. The more realism, the more options, the more difficulty selecting a path.

One approach to addressing planning complexity is called Hierarchal Artificial Intelligence (AI) Planning. See Chan, H., Fern, A., Ray, S., Wilson, N., & Ventura, C. (2007, April). Online Planning for Resource Production in Real-Time Strategy Games. In ICAPS (pp. 65-72). See also Shivashankar, V., Kuter, U., Nau, D., & Alford, R. (2012, June). A hierarchical goal-based formalism and algorithm for single-agent planning. In Proceedings of the 11th International Conference on Autonomous Agents and Multiagent Systems-Volume 2 (pp. 981-988).

Systems implementing Hierarchal AI Planning operate by iteratively adding detail to an abstract plan. For instance, consider an autonomous agent planner tasked with outlining a plan of actions to achieve the goal of getting a person to the office in the morning. The agent begins with a set of high-level goals, e.g., for an individual starting their day, goals such as: get up, get ready for work, get to work. Each of these goals is then refined into smaller, more detailed, and more actionable sub-goals. This continues until each goal and sub-goal is reduced to a list of primitive actions. Each primitive action is an action that the agent knows can be simply completed without further refinement. Here, assume that “Get Up” is a primitive action, and there is an action “Leave Bed” that changes the state of the person from the “In Bed” state to the “Up” state.

Meanwhile, “Get ready for work” must be broken down into “Do morning workout”, “Shower”, “Eat Breakfast”, “Do Hair”, . . . etc. Each of these goals may be further refined again, repeating until every goal has been fully broken down into primitive actions. There is generally more than one way to break down each goal for an agent, for instance, there could be several methods to get to work: maybe you drive, or maybe you ride your bike, or maybe you go on a wild parkour adventure, each method is relevant to the goal of “Get To Work”, but only some will be applicable depending on the conditions the agents is under, e.g. “car is in the shop”.

### SUMMARY

A computer-implemented planning agent uses a dictionary of goal, action, and method refiners to build a refiner tree rooted in a top-level goal. Goals indicate desired values of variables, actions mutate values of variables, and methods decompose higher-level goals into lists of lower-level goals (sub-goals). The variables pertain to a set of objects describing a simulated world comprising a model of a natural, manmade, or imaginary environment. Refiner trees can be constructed for each goal of a strategy made up of a number of top-level goals.

Each tree is built by iteratively relevance binding refiners to distal nodes of the tree, according relevance to the node as defined in the dictionary, then applicability binding those added refiners supported by the current state at that node of the tree. When one or more branches achieve a state in which the top-level goal is achieved, a plan made by choosing the actions along a selected successful branch.

The refiner tree can be solved independently of consideration for the actual time in which the actions of the plan will be executed, and a schedule subsequently be developed by, e.g., atomizing starting and ending conditions for each action and grouping the atomized components in parallel, to the extent permitted by the dependencies between actions.

Strategies can be created using, e.g., menu selection and/or natural languages interfaces to convert the intentions of users in goal formats defined in the dictionary.

An agent may or may not have perfect information about a modeled world, and the modeled world may have imperfect information a real world with which it is intended to interact. To address uncertainties arising from unforeseeable conditions and events, numerical controller can be used, or functionalities can be used to execute schedules and/or monitor the progress of schedules in achieving plans. When issues arise, the numeric controller can search for corrective actions through the use of relevance and applicability binding, or search for corrective plans of actions through the use of iterated relevance and applicability binding.

Such agents can be used to aid players in strategy games, for instance, or to implement non-player characters in such games, e.g., where the complexity of potential scenarios prohibits scripting actions a priori. Similarly, such agents can be used in a variety of simulation and/or real-world control scenarios, such as those involving autonomous or semi-autonomous vehicles and/or equipment.

### BRIEF DESCRIPTION OF THE FIGURES

FIG. 1 is a block diagram of a computer-modeled game world where three players attempt actions, and two of the players are assisted by planning and execution agents.

FIG. 2 is a block diagram of a planning and execution agent 202 operating in a computer-modeled world.

FIG. 3 illustrates the construction of a planning tree via relevance and applicability binding.

FIG. 4 illustrates the management of multiple planning trees for different strategic goals.

FIG. 5 illustrates converting a dependency-ordered plan into an optimized schedule via first splitting the plan into atomic start and end steps.

FIG. 6 illustrates checking a for consistency in schedule for achieving planned outcomes, identifying corrective actions, and adjusting the schedule accordingly.

FIG. 7 is a map illustrating the introduction of an impediment introduced into a landscape that can require adjusting a schedule, identifying corrective actions, and/or re-planning.

FIG. 8 is a flow diagram of a process for using AI planning agents in a computer-modeled world.

FIG. 9 is a flow diagram of a process for computer-modeling a world to facilitate the use the AI planning and execution agents described herein.

FIG. 10 is a flow diagram of a planning process implemented by an AI agent.

FIG. 11 is a flow diagram of a scheduling process implemented by an AI agent.

FIG. 12 is a flow diagram of a schedule execution process implemented by an AI agent.

### DETAILED DESCRIPTION

### Introduction

Artificial intelligence (AI) agents assisting planning and execution in computer-modeled worlds face real world time constraints. Whether the modeled worlds are used for training, gaming, research, or control of real-world operations, for example, speed in effective decision making can be more important to stake-holders than identifying an optimum approach via exhaustive searching. Otherwise perfect solutions are useless if delivered untimely. Planning agents need to work quickly to allow real-time effects to take place simultaneously with other effects in the modeled world.

Techniques for efficient planning agents must account for the exponentially expanding options for streams of actions to be taken in pursuit of a goal. To simplify computational complexity, and therefore the time and computing resources need to arrive at a solution, conventional AI planners generally assume a “static world” where: there is only one AI agent; every action the agent attempts will succeed; and actions are executed instantaneously. These assumptions do greatly reduce computational complexity, but generally do not properly account for the activities of other actors such as other agents, risks of the failure or partial effectiveness of actions taken, contingencies endemic to the modeled world, and delays in action execution times seen in the real world and in any realistic simulation.

Herein, we describe techniques for relieving automated planning agents from the constraints of the static world assumption and managing computational complexity by other technical means. These techniques include, inter alia: the use of separated relevance and applicability binding in the formation of planning trees; first forming planning trees to find dependent tasks, without regard to the timing of execution, and then scheduling after one or more plans of dependent tasks are selected; developing schedules via atomic isolations of starting and ending condition components of dependency-ordered plans; use of relevance and applicability binding to identify corrective actions to be taken to account for errors in plans, errors in schedules, and/or contingencies discover in the course of attempting to execute a schedule. These and other techniques described herein can be used in any combination.

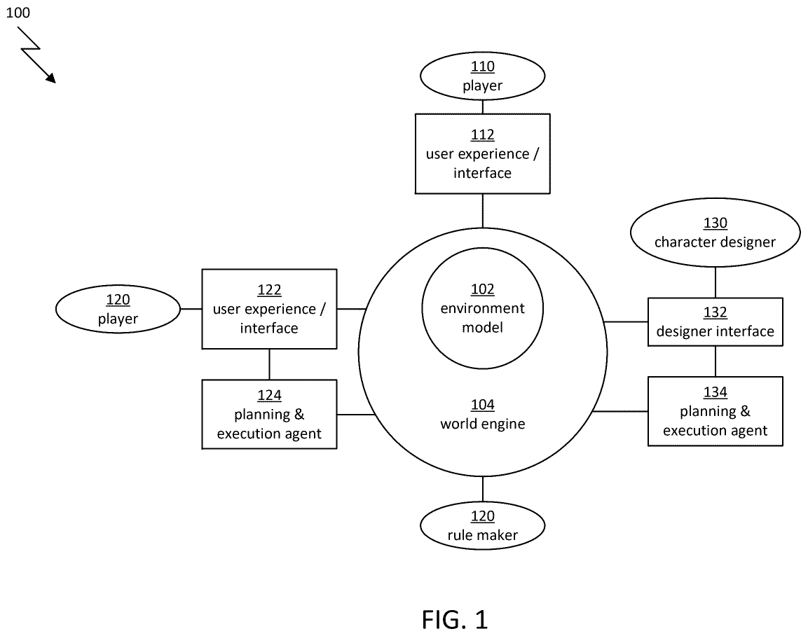

### FIG. 1—The World

FIG. 1 illustrates an example computer-modeled world 100 acted upon by three characters, including two human players 110 and 120 (which can appear as avatars in the world 100), and a non-player computer-controlled character whose activities are, at least in part, scripted by a designer 130.

At the core of the world 100 is a model 102 of the environment containing the states of the variables of the world 100. The variables can be anything useful in describing the simulation, such as: maps and characteristics of the landscape of physical environment; objects in that landscape; numbers, positions, and characteristics of the objects; claims for control of locations and objects in the landscape; records of achievements or failures, such as improvements in knowledge or degradation of living conditions of inhabitants of the landscape; capabilities of the actor; and/or abstract resources or conditions, such as morale, alliances, treaties, know-how, technology, etc.

The players in a world can be, e.g., characters in a game, combatants, lifeforms, or other entities with some form of agency over objects in the world. In some worlds, e.g., role-playing strategy games, things like trees are not treated as players. But in a world modeling a biospheres, for example, trees can be viewed as players to the extent that they may be described as having a strategy, e.g., a set of high-level goals (policies) of surviving, thriving, and propagating that can lead to a plan to achieve those goals by taking advantage of available resources over time. Herein, the terms players, actors, and characters are often used interchangeably in the examples.

Where there are multiple players in a world, typically each player will vie against or cooperate with other players to achieve those goals. This normally plays out, for purposes of planning, as tasks—streams of actions to be performed—to obtain and use resources. In the context of the world 100, those resources are the territory (e.g., land, sea, waterways, air, space), object in the territory (e.g., ore, arable land, forests, farms, factories, livestock, wildlife, people), agreements (e.g., treaties, contracts, laws, etc.), and abstract assets (e.g., morale, know-how, technology, reputation, good will, etc.)

The world 100 can be defined by a world engine 104, which is a collection of rules by which the simulation is governed and mechanisms by which the rules are enforced. These rules can include, for example, definitions of the actions that are permitted to permute objects in the environment, e.g., through the consumption of resources over the passage of time. The rules can further include goals that may be achieved in the landscape, e.g., the elimination of undesirable objects or generation of desirable object, the control of territories, awards for competitive or cooperative activities, development of knowledge or morale, etc. Further, the rules can include methods of converting higher-level goals into lower-level goals and/or actions which achieve the higher-level goals.

The rules of the world engine 104 can further control the manner in which players have access to knowledge of the environment 102, and/or the sequence in which players are allowed to act upon the environment.

In the example of FIG. 1, player 110 operates without the benefit of an AI agent. Player 110 has a user experience and control interface 112 by which the player 110 views conditions of the world and issues requests to take actions, e.g., the disposal of resources assigned to player 110 toward goals of the acquisition of new resources and/or attainment of higher-level goals.

Player 120 represents another human player that has a similar user experience and control interface 122 relative to which inputs, inter alia, are received from the human player. Player 120 further has an AI planning and execution agent 124 by which a strategy of player 120 consisting of top-level goals, i.e., strategic goals, which the agent 124 may convert into a plan of actions and a schedule of the order in which to take those actions, in view of expected states of the environment 102. The agent 124 further assists with executing the scheduled actions and adjusting the actions taken and/or goals sought based on contingencies.

In addition to the human players 110 and 120, world 100 has an autonomous actor, not shown, that is defined by a designer 130 and implemented by agent 134. The designer 130 may be a game designer introducing a “non-player character” (NPC) into a strategic simulation or role-playing game, for instance. Similarly, the designer 130 may be introducing an antagonist with assumed characters for a military simulation used for training or combat theater contingency planning. Similarly, the designer 130 may be a researcher positing a model of behavior of an entity, e.g., an animal species or a bacteria, in the context of a world 100 that simulates a biosphere.

The designer 130 interface 132 can have features that are similar to those of the interfaces 112 and 122 used by players 110 and 120 for viewing aspects of the environment and/or submitting strategies. The designer interface 132 can be distinguished in having privileges, or enhanced privileges, for introducing goals and/or methods into the world engine 104, and/or for introduction or modification of the landscape, objects, and/or criteria for achievements and/or failures.

Additionally or alternatively, a separate interface and/or developing environment can be provided for a rule maker 120 for architecting the environment 102 and world engine. For example, the rule maker can determine: the sequence in which players and non-players act (e.g., one at a time or simultaneously); the knowledge of the environment and/or strategies visible to each player.

Generally herein, the period of time during which a strategy is implemented is called a phase of action. A phase of action of is divided into turns.

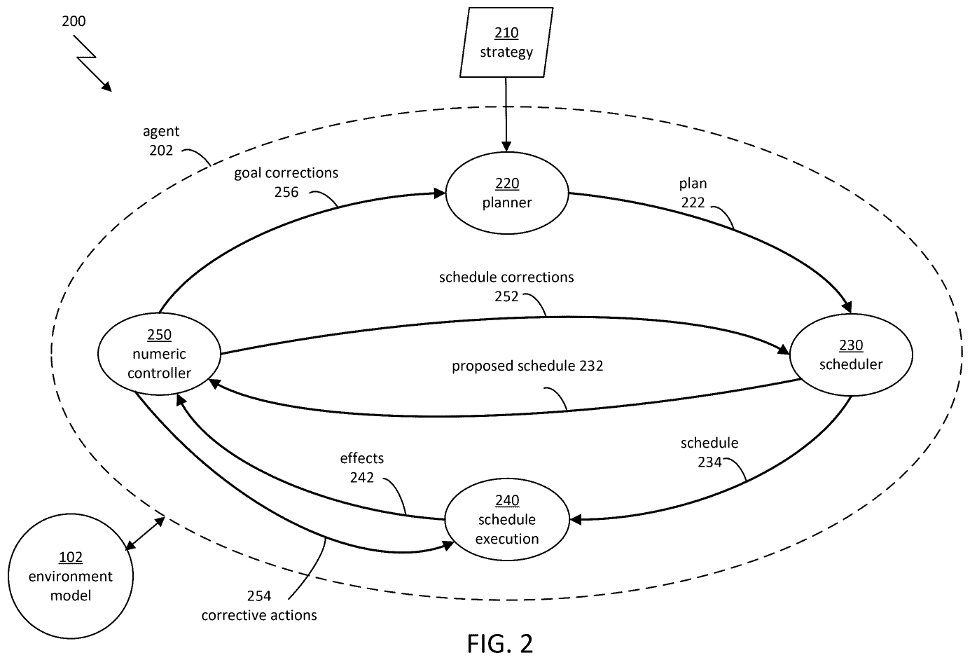

### FIG. 2—The Agent

FIG. 2 illustrates a planning and execution agent 202 operating in a world like world 100 of FIG. 1. The agent 202 of FIG. 2 may be, for example, either or both of the planning and execution agents 124 and 134 of FIG. 1. The operations of the agent 202 can be viewed as occurring in four major functional blocks: a planner 220, a scheduler 230, a plan execution module 240, and a numeric controller 250.

### The Planner

The planner 220 takes in a strategy 210 including top-level goals (strategic goals) hoped to be achieved by an actor. The actor can be representative of a human player of game, a non-human player character created by a game designer, or some modeled entity in a real or imagined context, i.e., a modeled world, which uses its capabilities and/or resources to vie against, and/or cooperate with, other actors in that world toward the achievement of the actor's strategic goals. The planner 220 translates, to the extent possible, into a list of actions to take to achieve the strategic goals using available resources given the state of the world.

Toward this end, it can be preferable for the strategy 210 be provided with a ranking of which top-level goals are to be pursed in which priority. For example, this can be a simple ranked list of strategic goals. The strategy 210 can further include contingency sets or systems of goals to pursue in case a strategic goal cannot be achieved, e.g., due to lack of resources or other contingencies.

All of the components of the agent 220 can receive information about the state of the world at a given time, e.g., the state of territories, objects, capabilities, etc. For example, planning can be undertaken for a phase of action that includes many turns, e.g., steps or time periods within the phase of action. For the phase of action, the planner 220 obtains—to the extent permitted by the rules of the world—information regarding all territories, resources, capabilities, etc., as of the start of the phase of action, including resources at the disposal of the actor for whom the agent 202 is operating, resources at the disposal of other actors in the world, and resources which are currently unclaimed.

### The Scheduler

The planner sends an unscheduled plan 222 to the scheduler 230. The scheduler 230 converts the unscheduled plan 222 into a timed schedule 234 that takes advantages of which tasks in the plan 222 can be undertaken in parallel based, e.g., on dependencies between tasks and/or the time necessary for the performance of each task.

### The Numeric Controller

The scheduler can send a proposed schedule 232 to the numeric controller 250 to check the assumptions of the plan 222 and proposed schedule 232. For example, the numeric controller 250 can confirm that the schedule 230 will achieve the scheduled strategic goals based on initial and generated resources, actions taken, and contingencies.

The numeric controller 250 can provide to the scheduler 230, either in response to receiving the proposed schedule 232 or on its own initiative, schedule corrections 252. For example, the numeric controller 250 can note that, at some point in the phase of action, the prerequisite resources are no longer available, or not available yet to perform a given action, but may be available at a later time. In this case, it may be possible to achieve the plan by merely altering the schedule. Toward this end, the numeric control 250 can send schedule corrections 252 to the scheduler.

Similarly, the numeric controller 250 can audit an overall proposed schedule to determine whether it will achieve the scheduled strategic goals, and similarly send schedule corrections 252 to the scheduler.

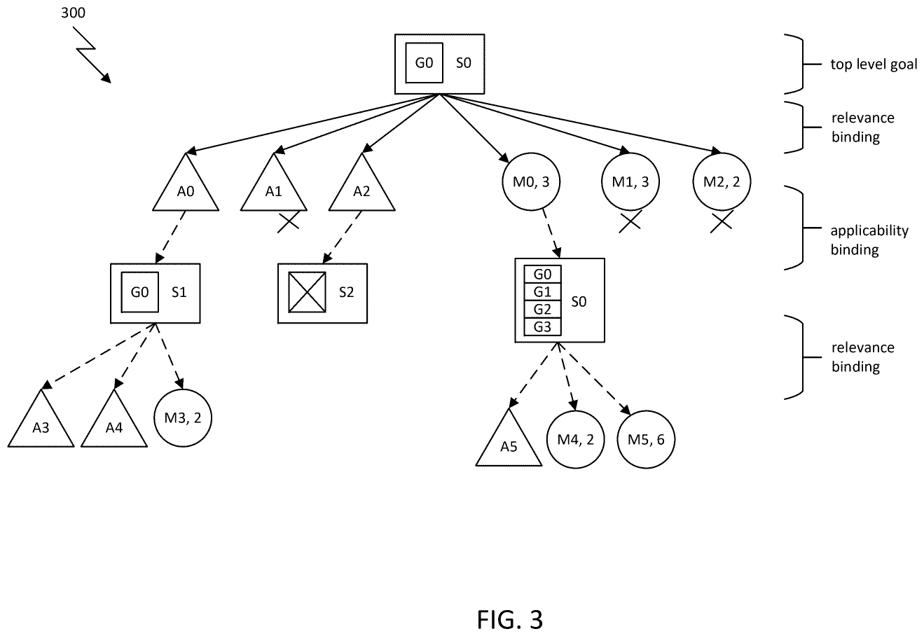

If the numeric controller 250 determines that the current proposed schedule 252 cannot be met, and therefore the planned and scheduled strategic goals cannot be accomplished, the numeric controller 250 can send a notice of this failure to the planner 220, causing the planner 220 to reconsider the strategic 210 in view of new information regarding the state of the world. This may involve, e.g., revising a plan by adding more nodes by relevance and applicability binding as described in reference to FIG. 3, or re-planning from scratch.

### Schedule Execution Module

In the example of FIG. 2, the scheduler 230 sends a schedule to a plan execution module 240 which checks whether conditions are met to take the next action in schedule 234. For example, the execution module 240 can check whether sufficient territory, capabilities, and/or other resources are available. If not, the execution module can notify the scheduler 230 and/or the numeric controller 250 of the failure.

If the conditions for the action are met, the execution module 240 takes the action by informing the environment model 102 and/or other components of the agent 202 of the effects of the action.

### Corrective Actions

The current state of the world changes whenever an action is taken by any actor. Further, changes in the state may arise out of non-actor phenomena, e.g., natural and/or random occurrences introduced by one or more rules of the world. Further still, the world may be a model of a real-world environment in which changes in the state can be observed, e.g., by sensors. The change in the current state may not be as expected by an actor. For example, a scheduled action may take longer than expected, produce inadequate effects, or fail completely, and may do so while nonetheless consuming associated resources.

Various aspects of the agent 202 can be adapted to deal with such contingencies. For example, when an action is executed by the execution module 240, the numeric controller 250 can revisit the status of the current plan and/or current schedule in view of the expected and/or actual results of the action. The numeric controller 250 can then provide a schedule correction 252 to the scheduler 203 or notify the planner 220 of a goal correction 256 that might require revisiting/modifying the current plan 222 and computation of a new schedule 234, as may be appropriate.

### FIG. 3—Planning Tree

### Goals, Actions, and Methods

FIG. 3 illustrates the construction of a tree 300 in a number of steps. The tree is rooted in a strategic goal G0 for a state SO of the world at a particular time.

Each goal, including top-level strategic goals, secondary goals, tertiary goals, and so forth, have conditions to be met, where the conditions pertain to combinations of variables being true in a state of the world.

Actions are ways to achieve those conditions. Actions may have start conditions which must be true to begin the action, end conditions which must be true to complete the action, and effects, such as the generation or attainment of new resources and/or consumption of resources necessary to the action.

Methods are lists of sub-goals which are defined in the system to be relevant to achieving one or more conditions of a higher-level goal. Methods can have conditions which must be met in a state of the world before they can be applied.

### Relevance Binding

The first step in the construction of the tree 300 is to relevance bind those actions, other goals, and/or methods that are defined in a dictionary of refiners to be pertinent to achieving the root goal. The relevance of a refiner to a goal is set a priori in the dictionary, prior to the work of the agent to produce and execute a scheduled plan of actions. The dictionary of refiners is part of the rules of the world, e.g., as established by the original designers of the world. The dictionary can be extended by authorized world rules administrators, for example, and/or extended by user in ways that are consistent other refiners and/or rules of the world. However, this is done outside of the agent.

In the examples of FIG. 3, three actions and three methods are relevant to the goal G0. These can be added to the tree in any order. However, it can be beneficial to rank them according to various criteria, e.g., according to their probability of success, economy of resources likely to be consumed, etc. In the example of FIG. 3, the actions A0-A2 are depicted on the left, and the methods M0-M2 are on the right, assuming a preference for left-to-right searching of the tree for a viable plan, where the actions are tested before the methods, e.g., since their effects are more easily computed.

### Applicability Binding

The next step is to applicability bind those relevance-bound refiners which are possible to achieve for the state of the world at the current node of the tree. Different branches of the tree will result in different proposed future states of the world, depending on which actions are taken to arrive at the node. For applicability binding, conditions of the relevance bound actions, methods, and goals are checked whether they are viable at his point in the plan implicit in the branching of the tree leading to the current node.

For example, and action of deploying a navy may be relevant to the goal of attacking an enemy in a military simulation world, as set in the dictionary of refiners. However, the action may have several pre-conditions to be met, such as requiring that the actor has a navy is not a land-locked nation. Hence, while the action relevance binds to the goal, the option is rejected as not currently practical.

Continuing the example, in an alternative world there may be additional refiners, including actions of acquiring sea access and building a navy, and a method initiating naval warfare which includes the actions of acquiring sea access, building the navy, and deploying the navy. Both the action of deploying the navy and the method of initiating naval warfare will relevance bind to the goal of attacking the enemy. But, by itself, the action deploying the navy will not applicability bind in the state where there is no navy, whereas the method of initiating naval warfare does not have a pre-condition of having a navy—or even sea access—and will applicability bind, provided its other conditions are met.

In the example of FIG. 3, for applicability binding, the conditions of actions A0-A2 and the methods M0-M2 are checked in the state S0. Action A1 and methods M1 and M2 are not viable in state S0. They do not applicability bind to the tree.

Action A0 does applicability bind, and so a new node is added to the tree. In this example, performing action A0 does not by itself satisfy the conditions of goal G0, but would in a hypothetical new state S1 which is closer to meeting the conditions of goal G0. A new node is bound to the tree on this branch denoting goal G0 at state S1.

Action A2 does result in meeting the conditions of goal G0 in a state S2. A new node is bound to the tree with no goal left to be achieved at the state S2. The building of the tree could terminate here, with the plan simply concluding with simply performing action A2. However, there may be other strategic goals to consider, so this can be just one of several solutions to goal G0 to be considered going forward.

Method M0 is applicable. It includes four sub-goals G1-G3. In the example of FIG. 3, these are shown in a single node along the branch along with G0. This propagates the requirements of G0 to the terminal node, e.g., for rapid evaluation. This completes a first iteration of relevance and applicability binding of the tree.

### Iteration

The tree can be completed by iteratively performing both relevance and applicability bindings. For example, iteration can continue exhaustively until all possibilities are discovered. Alternatively, iteration can cease once any solution state is found.

Further, iteration can be limited to, e.g., 1,000 iterations, whereupon some criterion or criteria for selecting one of the discovered solutions, e.g., by traversing the tree branches from left to right, or the first solution found that meets multiple criteria balancing achievements versus the expenditure of time and resources. If no solution is found within the iteration limit, the top-level goal may be abandoned.

### Speed Advantages of Binding Approach

The use of the dictionary of refiners permits automated unscheduled planning to execute very quickly, e.g., via the use of rapid searches of limited lists of relevant refiners. Further economy of speed can be enhanced via coding which permits general definitions of types and type checking, such that few named refiners and few types need to be check. The result, e.g., in contrast to planning methods requiring exhaustive searches, is to provide plan generation in real-time or near-real time. For example, a simulator operator or player of a game may need to wait only seconds for a plan to be formulated from a new strategy. Similar, in the case of robotics/industrial facilities management, the agent may be able, using the techniques described herein, to formulate and act on plans within the time frames required for management of operations, even before any human operator may be able to be made aware of or respond newly sensed conditions. Herein, “real-time” is relative to the context contemplated, which may vary, for example, from sub-second responses for machine operations to several minutes or more for human actor convenience in simulated worlds with no connection to a real physical environment.

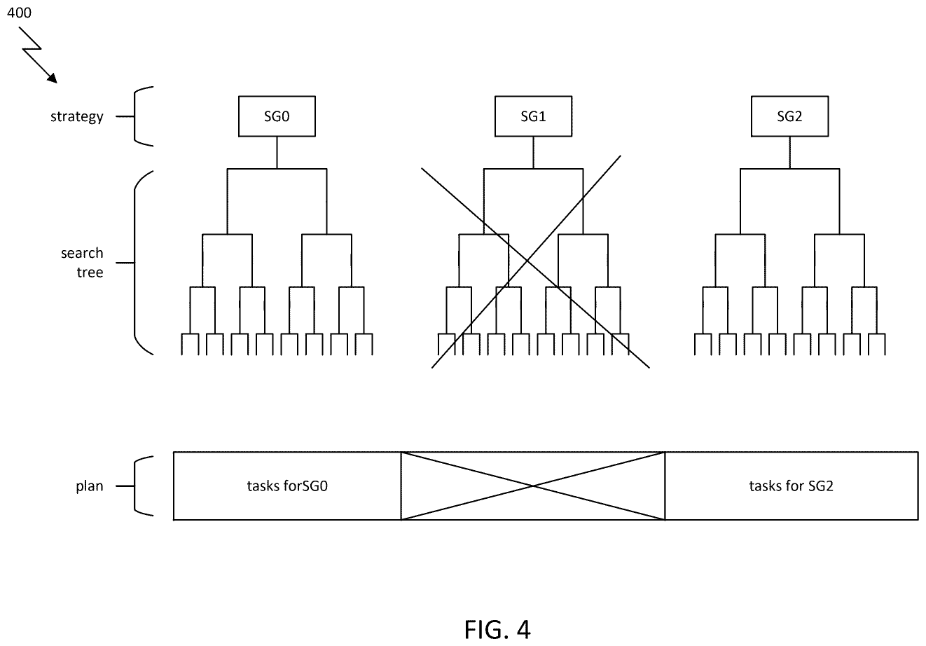

### FIG. 4—Plannable Goals

FIG. 4 illustrates trees 400 used to determine whether strategic goals SG0-SG2 are plannable. In this example, the goals SG0-SG2 are in ranked order. The agent begins by building a tree for goal SG0 by iteratively applying relevance and applicability bindings to the goal, e.g., in accordance with the technique described in reference to FIG. 3. Here, at least one solution is found for planning the achievement of goal SG0 within the limits of the available resources for a given starting state of the world. The selected branches of the tree go into the plan.

Next, using a selected adjusted state of the world in which goal SG0 is achieved, the agent then constructs a tree for goal SG1 in the same manner. However, here a solution is not reached, e.g., due to impossibility or not finding a solution within a given limit on the time or iterations available to be devoted to the tree search task. Therefore, the hypothetical consumption of resources for goal SG1 are ignored, and the effort is not included in any plan. Goal SG1 is skipped.

Coming to SG2, again a tree is again built to search for a solution, and again using a selected adjusted state of the world in which goal SG0 is achieved. Here again, a solution is found, and the selected branches are used to build a portion of the plan to achieve goal SG2. The agent seeks ways to accommodate as many strategic goals as possible in the plan.

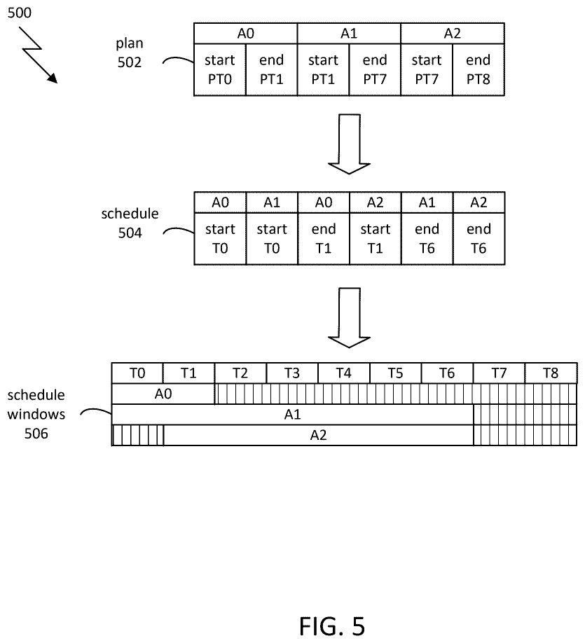

### FIG. 5—Atomic Tasks in Scheduling

FIG. 5 illustrates a flow 500 in which a plan 502 is converted into a schedule 504 in which scheduling windows 506 are made apparent. When the construction and searching of a tree by a planner reveals a path through the branches that results in a solution to achieving a top-level goal, that path may be read as a list of actions to be done sequentially. Such a path, while unscheduled, may be totally ordered with respect to dependencies, and therefore constitute a totally ordered, unscheduled plan.

Actions can have conditions for beginning the action, conditions for ending the action, and, e.g., a minimum duration required to complete the action. Plan 502 of FIG. 5 is shown have three actions, A0-A2, which are laid out with start and end times measured in “plan turns” (designated PT in FIG. 5.) These plan turns may or not correspond to those turns of a phase of action into which these actions are initial scheduled. Similarly, the plan turns may or may not correspond to the those turns of a phase of action in which the actions end up occurring.

The scheduler can proceed to convert the plan into a schedule by first dividing each action into its atomic stand and end sub-actions, then checking dependent conditions for which actions must wait for completion of other actions before starting.

Assume in this example, action A1 does not require that action A0 ends before action A1 starts. Therefore AI and action A0 can be scheduled to both start in scheduled turn TO. Starting action A2, however, requires that action A0 be completed first. Action A2 can start in scheduled turn T1 when action A0 is complete. Alternatively, depending on the rules of the work, A2 may have to wait until the turn afterward to begin.

To end, action A2 requires the successful end of AI. Here, AI starts one turn earlier in the schedule than in the plan. In the schedule, action A1 ends at scheduled turn T6, two turns quicker than in the plan.

A useful view of schedule 504 is seen in the schedule windows of 506. The windows 506 reveal opportunities for using overlapping windows 506 to execute the plan faster in the schedule, e.g., by starting actions AI and A2 sooner.

Further while action A2 only requires one turn of effort to complete, the windows 506 illustrate that such effort may occur of in any of six turns without deviating from the overall schedule 504. This may provide agility to the agent to resolve conflicts arising from contingencies, e.g., in being able to defer the use or consumption of resources to a later, more convenient time, rather than as soon as the start conditions for action A2 are met.

Speed Advantages of Scheduling Approach Decoupling planning and scheduling, and the use of atomic division of sub-actions, allow rapid automated processing. As with planning, here the computerized agent faces only a set of simple computations. Therefore schedules can be built, and/or modified as required, in real-time or near real-time.

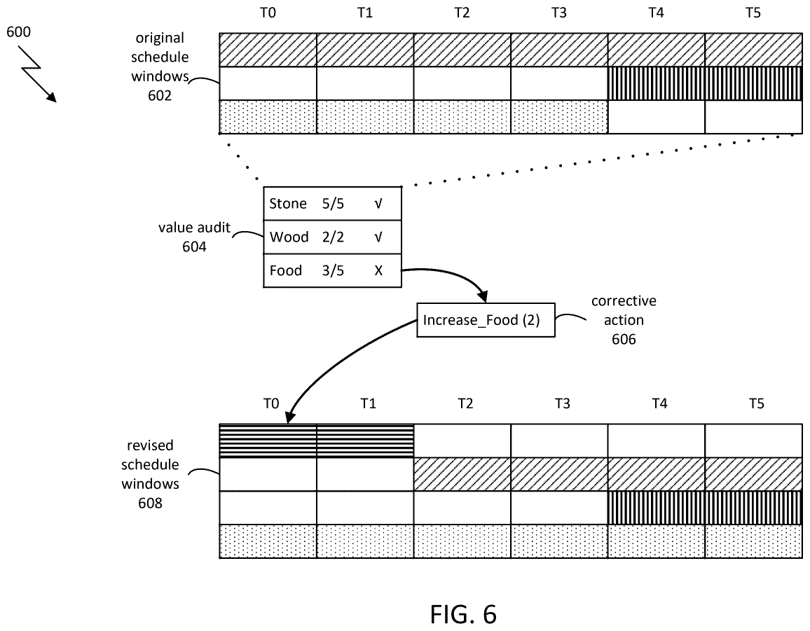

### FIG. 6—Checking Values

FIG. 6 illustrates a process 600 for checking and correcting values achieved by a schedule for values of objects in an end state. The schedules 602 and 604 show windows in which actions may take place. In the original schedule, the top task may be occurring in any of turns TO-T5, the middle task only in T4-T5, and the bottom task on in TO-T3.

A value audit 604 is conducted, e.g., by the numeric controller or similar functionality located elsewhere in the agent. The value audit 604 reveals that, while the schedule produces sufficient wood and stone resources, food production has fallen short. Perhaps has contingency has arisen which increased the need for food in a way that could not have been anticipated by the planner, or the schedule violated a rules of the world of which the planner or was unaware. The planner may not have perfect knowledge of the world or of its state at any given time—neither of the character or control of the landscape or resources, e.g., as controlled by other characters, or even of the character that the agent assists.

In the example of FIG. 6, a quick fix is identified. This can be achieved by the agent in a number of alternate ways. For example, the agent can find a relevance binding for a corrective action 606 which achieves the goal of meeting the shortfall in food production that would otherwise inhibit satisfaction of a scheduled strategic goal. If a relevant action is bound, the agent checks that the action is applicable, e.g., the conditions of the action can be met using available resources, i.e., resources which are not already committed to execution of the plan. If the action is bound as applicable, the agent can then check for schedule impact. If the corrective action 606 can be fit into the existing schedule, the agent can proceed with the correction, e.g., by informing the scheduler of any necessary adjustments, and/or sending the corrective action to the execution module for immediate implementation, depending on circumstances of timing.

In the example of FIG. 6, the corrective action 606 is identified as relevant and applicable. Further, the corrective action 606 can be fit into the existing schedule without significant impact. In this case, as seen in revised schedule 608, the top task of original schedule 602 can now not begin until turn T2. Fortunately, though, more flexibility has been added, whereby the bottom task of original schedule 602 can now continue through turns T4 and T5.

Other scenarios and operations are contemplated. For example, a simple fix—a single action—may not have been identified. The agent could search instead for both methods and action, producing a corrective action plan tree, e.g., with narrowly limited iterations.

However, the complexity of folding a new chain dependent actions into an existing schedule may be counterproductive to the efficient sought via, e.g., dividing the work of the planning tree into relevance and applicability binding, and further reserving the processing of timing considerations to the scheduler after a successful plan is identified.

Therefore, if a simple fix cannot be identified, the agent, e.g., via the numeric controller informing the planner of the failure of plan—in this case, the shortfall of two units of food—to trigger re-planning, to be followed by rescheduling.

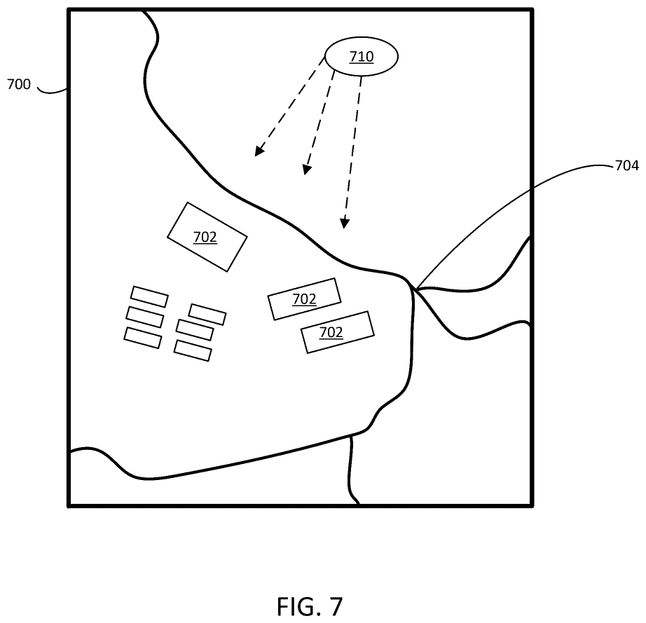

### FIG. 7—Checking Schedule

In addition to checking values produced by a plan, numeric controller functionality can monitor changes in timing and identify corrective actions accordingly. Map 700 of FIG. 7 illustrates a scenario where, according to plan, a factory complex 702 has been established by a first character near a strategic crossroads 704. The first character has expectations for how productive the factory complex 702 will be based on its size and positioning. However, during a phase of action to the surprise of the first character, a second character has placed an impediment 710, e.g., a base camp for raids, a sniper tower, a polluting mill, etc., which attacks and inhibits the factory complex 702. The net effect of the impediment 710 is not to destroy or seize the factory complex 702, but merely to slow it down.

The agent could check whether the change in productivity affects the schedule, either requiring changes in the windows in which streams of actions occur, a total rescheduling, or an expected failure of the plan and need for re-planning. Where the plan still appears to be achievable, the agent may, e.g., inform of the scheduler of corrections to the schedule and/or the need to reschedule completely. In the case of an anticipated failure of the plan, the agent can seek a corrective action plan, e.g., a simple fix, and/or inform the planner of the expected failure.

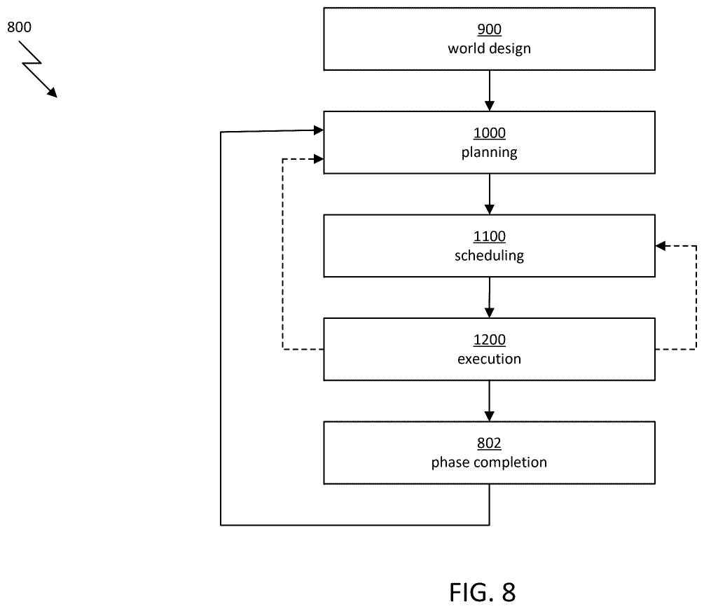

### FIG. 8—World Creation

FIG. 8 illustrates a process 800 for using AI planning and execution agents in computer-modeled worlds. FIG. 8 is described, inter alia, with reference to objects in FIG. 1.

Flow 800 begins world design 900, wherein one or more rule makers 120 model the world. This includes defining the space in which the world exits, e.g., a geographic or celestial landscape, an epidemiologic framework, a biosphere, a biome within a living creature, etc. The rule makers 120 define the objects and characteristics of the world, and their interrelation, e.g., how much time and labor are needed to convert an acre of timber into a number of cords of seasoned firewood, or what achievements are necessary to establish trust between neighbors. The rule makers further establish tools for planning in the form of defined goals and actions and methods for achieving goals.

World design 900 further comprises populating the world with an initial set of objects and characteristics, such as the quantities of objects and their properties, the kinds of actor having independent agency in affecting the world, perhaps specific actors and their strategies, as well as the allocation of objects among actors, e.g., which actor, if any, has possession of which objects and characteristics. These states are captured in the environment model and collectively referred herein as the state of the world.

Once the world is designed, with the assistance of AI agents, actors can plan their activities with the assistance of agents in step 1000. Then, separately, the agents convert plans into schedules in step 1100. Scheduled plans can then be executed by the agents in step 1200.

When a schedule and/or a phase of activity is complete at step 802, the process my repeat by returning to planning 900. This does not preclude changes in the world design, e.g., by rule makers 120. Nor does it preclude changes in the actors, e.g., the death of a player character, or the alteration, removal, or addition non-player characters.

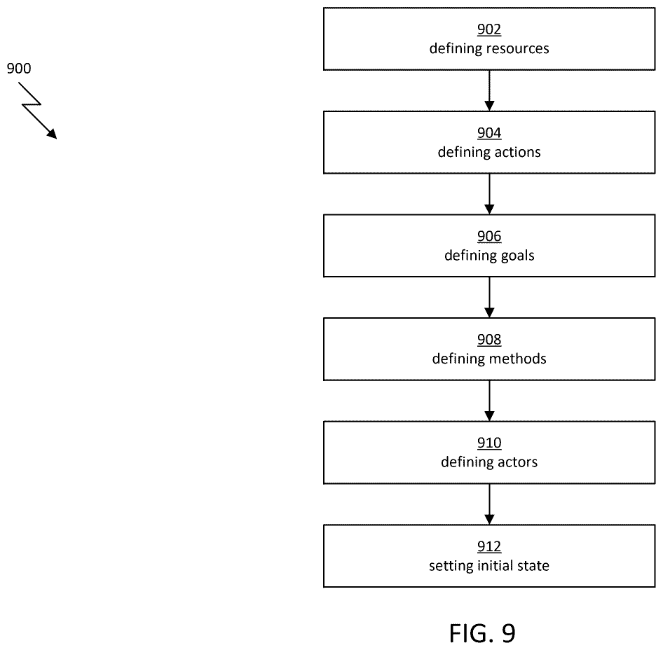

### FIG. 9—Design Flow

FIG. 9 is a flow diagram of a process for computer-modeling the world to facilitate the use the AI planning and execution agents described herein. The designers must define the space the world occupies, the objects and characteristics of the world, and rules by which the objects and characteristic may—and may not—interact. This may be viewed a set of separate steps as shown in flow 900 of FIG. 9. Flow 900 can be performed, for example, by the rule makers 120 of FIG. 1 and or other world designers.

In step 902 of FIG. 9, the rule makers 120 define classes of resources. Here resources problem means anything can affect the simulation, such as landscapes, objects in the landscape, and intangible characteristics. Herein the term resource is used generically, regardless of whether any particular actor controls the resources at any given time. Resources under control of an actor are referred to as available resources.

In step 904 the rule makers 120 define actions. Each action has a set of conditions for starting and completing the action, perhaps time and/or available resources that must be used and/or expended for success of the action, and additional effects that result from successful and/or unsuccessful termination of the action. The conditions are states of resources at different times, e.g., the time when an action is attempted, the time the action is occurring, and the time when the action terminates.

In step 906 the rule makers 120 define goals in terms of conditions necessary to complete each goal, and perhaps additional effects of achieving goals.

In step 908 the rule makers 120 define methods. A method breaks a goal down into sub-goals which, if all the sub-goals are achieved, would result in the goal being achieved. In addition to sub-goals, methods can have may have start and/or end conditions, and/or effects.

In step 910, the rule makers 120 and/or character designers 130 of FIG. 1 can define roles to be played by human actors and/or autonomous entities. For example, for strategy role-playing game set in context of an historical war, the design can set attributes of combatant nations, including strategies to be followed by one or more nations, whereby a human player can opt to play the part of one of the nations, and agents are used execute strategies of non-player nations. Similarly, a human play can be an overnight shift manager for a real-world factory for whom designer have modeled the factory and additional modeled bots that can be assigned routine tasks. The bots, in response to real-world information can alter their specific actions while continuing to pursue a high-level goal, without specific input from the shift manager.

In step 912, the designers an initial state in the environment model 102. This includes who owns which resources at the beginning of the simulation.

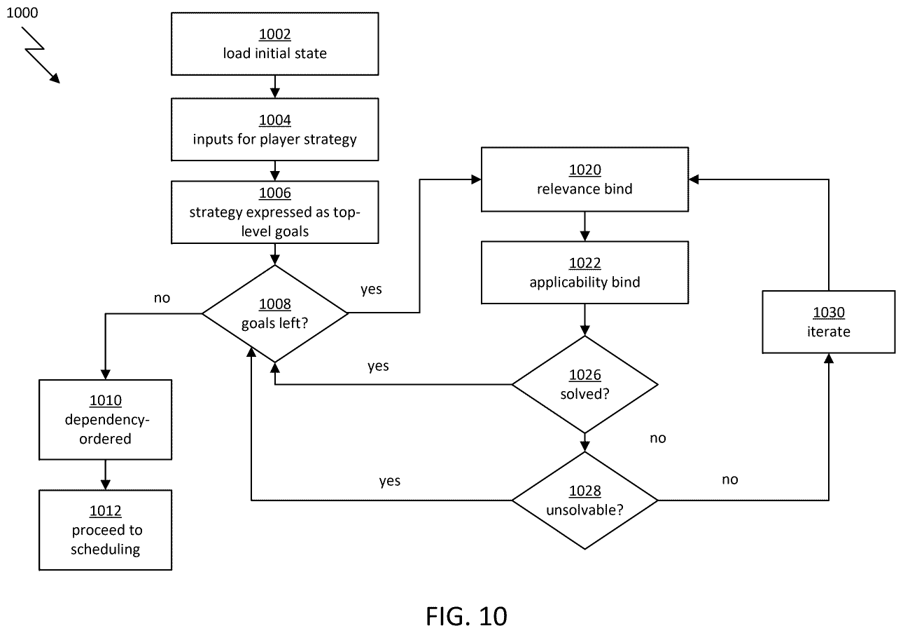

### FIG. 10—Planning Flow

FIG. 10 is a flow diagram of a planning process implemented by an AI agent. Herein, FIGS. 10, 11, and 12 are generally described in terms of an agent assisting a human player. However, in various worlds, this may be the exception. For example, and military strategy game, there may be only one human player who plays with or without the aid of an AI agent, while there are dozens of competing characters operated by AI agents using pre-scripted and/or randomly selected strategies.

For processing convenience, an agent can maintain models of world states locally, e.g., rather than relying on a central server, for faster execution. In any case, planning begins at step 1002 by obtaining a record of the current state of the world at the time that planning occurs. This allows human players to understand their options and further allows the agent to assist in evaluating with high-level goals may be obtainable given current available resources and knowledge of the resource which are in the hands of other players or unclaimed.

At step 1004, the player—or some other entity wishing to design a plan for, e.g., a non-player character, perhaps after reviewing information about the state of the world, inputs their ambitions for the next phase of action in the simulation.

In step 1006, the agent records a strategy for the player expressed as top-level goals, where each goal is in a format prescribed by the world's rule makers. A human player can input these directly, or the agent can utilize a system of menus and/or natural language process to convert the player's ambitions into goals in the forma which are processed by the agent.

For each goal in the strategy, as described in reference to FIG. 3, the agent performs relevance binding 1020 and applicability binding 1022 iteratively. After each round of first relevance binding 1020 and then applicability binding 1022, the agent in step 1026 can search the resulting planning tree to check whether one or more viable plans for achieving the strategic goal. This can be done for each iteration or after a number of iterations.

If at least one solution has been identified, at step 1026, the agent can choose one of the solutions, e.g., according to one or more criteria of speed of or economy, and/or with input from the player. As described in reference to FIG. 4, at step 1026 of FIG. 10, once finding a plan for the current goal, the agent returns to step 1008 to see whether there are additional goals to plan.

If at step 1026 a solution has not been identified, in step 1028 the agent checks whether the challenge is probably unsolvable, e.g., for lack of sufficient time or available resources. This can be done, for example, by capping the number of iterative cycles permitted for the planning effort for one or more goals. Additionally or alternatively, the agent can cap the size or other characteristics of the planning tree.

At step 1028, if the challenge is not deemed unsolvable, the agent can proceed to grow the tree through iteration at step 1030 by proceeding to another round of relevance binding 1020 and applicability binding.

If at step 1028 the challenge is deemed unsolvable, then as described in reference to FIG. 4, in FIG. 10 the agent deletes the unobtainable goal from the strategy and cycles back to step 1008 to see if there are other goals which may be obtainable given constraints on available time and/or available resources.

At step 1008, when planning has been attempted for all strategic goals, the agent proceeds at step 1010 to finalize an overall plan that includes all achievable goal. This can involve producing a single dependency-ordered list of actions assembled without reference to actual timing of when any given action should be performed. Rather, the dependency-order list can include tasks—sets of actions for achieving a goal or sub-goal—in the order they must be achieved. The result is an unscheduled plan to be used in scheduling.

Not shown in FIG. 10, the agent can notify the player regarding which goals were obtainable for strategy presented, and optionally offer the player to option of altering the strategy.

At step 1012, e.g., after obtaining approval of the plan from the player, the agent shifts from a planning mode to a scheduling mode.

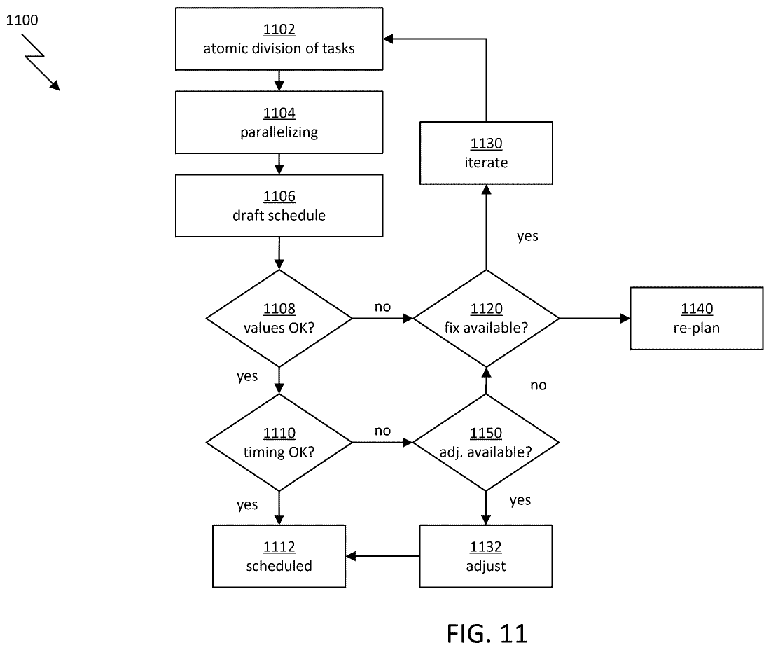

### FIG. 11—Scheduling Flow

FIG. 11 is a flow diagram of a scheduling process implemented by an AI agent. Using an unscheduled plan, such as that produced by process 1000 of FIG. 10, at step 1102 the agent divides each action into its atomic starting and ending conditions, as described in reference to FIG. 5. Here the agent is agnostic as to the effects of actions, as this has already been accounted for in planning.

At step 1104 of FIG. 11, the agent groups the separated atomic starting and ending conditions into the earliest turns of time in which each action can start and end, based on dependencies.

At step 1106, the parallelized results of step 1104 become a draft schedule that can be checked in a number of ways via numeric controller functionality.

For example, at step 1108, the agent can check that the plan is sufficiently like to produce expects the values of resources expected to achieve the plan, as described in reference to FIG. 6. For example, the player may have had imperfect information when beginning planning, and now the plan falls into doubt. Similarly, actions may not be certain in their duration or effect and stacking probabilities in chains of dependent action—e.g., via Bayesian analyzes, may yield an insufficiently promising prospect of success.

If at step 1108, the values produced by the schedule are in doubt, the agent can attempt in step 1120 to find a fix. As described in reference to FIG. 6, here the agent can identify a simple fix in the form of an action that binds for relevance and applicability and has the effect of curing the deficit values. Additionally or alternatively, the agent can seek a remedial sub-plan by iteratively relevance and applicability binding actions and methods.

If at step 1120 a fix is available, at 1130 the agent can iterate the schedule, e.g., by inserting the new tasks and/or restarting scheduling using a revised play.

If at step 1120 there is no fix, at step 1140 the agent can report a failure to the planner, requiring the development of a new plan. In practice, the option of re-planning may be held in reserve until a scheduled action cannot be executed. That is, even if at step 1120 there is no fix or adjustment available, because of the computational resources required for re-planning it may be preferred to continue with the schedule, e.g., in hopes that detected shortfalls are compensated for in other ways.

As described in reference to FIG. 7, numeric controller functionality can also check assumptions about achieving actions in a given time frame. In FIG. 11, if at step 110 the numeric controller detects issues with timing, it can at step 1150 suggest adjustments to the schedule. This can be improvements in speed, spaces in the schedule tasks, and or other revisions to expectations for the times when actions will actually start and end.

Changes to the timing can disrupt the schedule. If at step 1150 adjustments to the schedule cannot be accommodated without disrupting dependent conditions, then the agent can proceed to step 1120 to attempt to find a fix and, failing that, go to step 1140 for re-planning.

If at step 1150 the adjustments can be accommodated, then in step 1132 the schedule is modified, and a schedule with sufficient confidence is produced in step 1112.

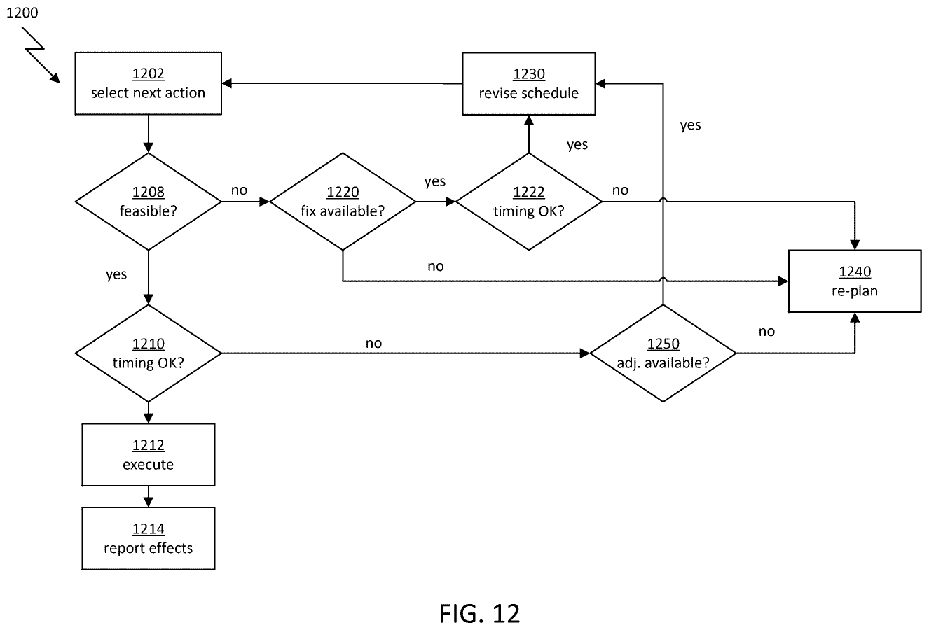

### FIG. 12—Execution Flow

The planning, scheduling, and numeric controller functionality described in reference to FIGS. 1-11 can also be employed in the adaptive execution of a planned schedule. FIG. 12 is a flow diagram of a schedule execution process implemented by an AI agent.

At step 1202 the agent selects a next action to execute. For example, for the first turn in a new phase of action, this would be one the actions scheduled for the first turn. There can be actions scheduled to start in each turn.

At step 1208, e.g., using numeric controller functionality, the agent checks the feasibility of the action by checking conditions of the action against the current state of the world. Here, the agent can be testing starting or ending conditions of the action, and both can occur in the same turn.

The current state of the world may be quite different from the initial state used for planning at the beginning of a phase of action. Actions taken by other actors and/or random contingencies can have significant impacts. Further, depending on the rules of the world, the agent can be instructed to introduce random delays, diminishment of effects, unseen consequences, and/or failure of actions.

If at step 1208 the action's conditions are not met, the agent can seek a fix, e.g., a quick fix single action that binds for relevance and applicability, or a remedial plan, in step 1220, and them verify timing impacts in step 1222, before revising the schedule in step 1230.

If a fix is not available or the timing is not acceptable, the agent can then report a failure of the scheduled plan at step 1240. In practice, the option of re-planning may be held in reserve until a scheduled action cannot be executed. That is, even if no there fix or adjustment available, because of the computational resources required for re-planning, it may be preferred to continue with the schedule, e.g., in hopes that detected shortfalls are compensated for in other ways.

Similarly, the agent can check at step 1210 whether the action's expected timing is met. If not, the agent can check at step 1250 whether the new timing is compatible with schedule, given flexibility in schedule action completion.

If at step 1250 the timing is acceptable, the agent can proceed to step 1230 to revise the schedule. Otherwise, the agent can report the failure of the scheduled plan at step 1240.

If the scheduled start and/or end conditions for the current action are met, and timing impacts (if any) are acceptable, the agent can execute start and/or end the action at step 1212.

Contingent probabilities can be accounted for in starting and ending conditions. For example, rather than checking that just enough resources are available to start an action, starting conditions may include a margin of error, e.g., sufficient surplus to start an action. Similarly, start and/or end conditions may include expressions of minimum or maximum expected outcomes of an actions. For example, an action is not started it is no longer probably expected to produce sufficient beneficial outcomes.

An agent can be working primarily from a local copy of the state of the world, e.g., subject to limitations on the player's visibility of the environment model per rules of the world. In step 1212, the agent notes in its records the effects on resources resulting from, e.g., the start and end of an action.

In step 1214, the agent can further report those effects to other players and/or a central server. This can be done selectively, for example, only when the effects regard resources not previously under the control of the player.

Not shown in FIG. 12, the agent can use, e.g., numeric controller functionality to track intermediary results of action as they occur in between the starting and ending turns of an action. For example, that state of the of the world can be adjusted to track the operations of a factory in consuming inputs and producing outputs. Similarly, numeric controller functionality can be employed to monitor that durative conditions of ongoing actions are being met.

### Coding Considerations

AI planning agents can be configured to accommodate violations of static world assumptions, e.g., in worlds where there are multiple agents, actions cannot be assumed to succeed, all actions take some amount of time, and actions may vary in how much time is needed to complete the action. The techniques described herein may be applied for planning in real and/or realistic environments. The techniques include the interaction of automated elements and interfaces for their configuration and manipulation.

The system has two main components: an AI Planner, and a Numeric Control System. They work in tandem to cope with violations of the static world assumption.

Given a goal specified in a compatible format, the Planner creates an ordered initial Plan to go from an initial State of the World to a State in which the goal has been completed. Once planning is complete, actions are Scheduled such that actions which can be completed safely in parallel are set to start together. This enables timing estimates on the total completion time of the Plan.

This Plan is then analyzed for numeric quantities which must be true for all of the planned actions to succeed. As the main Plan is executed, the cooperative numeric control system stabilizes the numeric quantities around the required values, performing actions from the planners' toolbox which do not interrupt the plan to control the values. See FIG. 1.

This cooperative strategy addresses the violations of the static world assumption by detecting and compensating for deviations from the expected state of the world due, e.g., to actions of other agents, or to non-determinism. The temporal aspects of the AI planner address the third point of the static world assumption that all actions should be instantaneous.

The result of the system is that long-term plans can be created in abstract, and the agent can begin to act on it. Where the state of the game would normally deviate until the planner can no longer follow the plan, the numeric control system usually brings it back on course by taking corrective measures. If the numeric control system fails to correct a deviation, then the planner is invoked again, and a new plan is created which works in the new state of the game, and the process repeats.

### Interface Structures

An interface to an AI planning and execution agent can be built on of a schema and data loading system which allows for the definition of schema structures, wherein each schema structure definitions includes an identifier naming an object type combined with a sequence of field definitions (similar to that of a structure definition in a language like C), each specifying a data type and a name. Thus, schema structures define the set of typed, named data fields used to load a particular object instance. The schema structure defines the expected layout of a particular data type for which many instances can be defined. Fields defined on a schema structure can be annotated with additional attributes, some of which are of significance to the AI interface.

For example, schema definitions can be provided for data elements useful to the AI agent such as goals, methods, and actions. In each such case there is a corresponding schema definition that provides a definition of the expected data layout of the object.

For each instance of such data elements in the interface, there is a body of structured text written in the data language which corresponds to the structure defined in the schemas. Using the schema definitions, the structured data text is parsed, analyzed, checked for errors and then processed into C++ structure instances used by the AI agent.

For example, schema structure data fields may be defined using the “string” type but also annotated with the “predicate” annotation. Each such string can then define a predicate expression. A predicate expression can be processed by an additional system which translates predicate logic expressions consisting of term expressions combined using logical operators (and, or, and not).

An Extended Backus-Naur Form (EBNF) grammar is illustrated in Code Example 1 of the Appendix. In Code Example 1, angle brackets denote a terminal character class, and quoted text are literals. Example predicates, per line, are illustrated in Code Example 2 of the Appendix.

The AI system provides a list of term definitions that specify the valid term names, their expected argument count, and the expected type (e.g., identifier or number) of each argument.

Predicates are processed by a predicate compiler which validates them for correctness against the provided term definitions and processes them into a compiled representation consisting of an array of term expression instances and a small bytecode program. Processing in the AI system on term data thus proceeds predominantly as operations on these term expression instance arrays.

### AI Interface Elements

The planning processes described herein require the authorship of refiners. There are three types of refiners: goals, actions, and methods. Goals indicate a desired state. Actions solve primitive goals by mutating state. Methods decompose goals into finer sub-goals. All refiners must be hand-authored per application of the system. That is, the refiners, inter alia, define the rules of the world, and thus must be tailored to the designers desired model of the world.

A programming language may be used to specify refiners in a compact fashion, whereby the interface to the AI system builds refiners from sets of terms made up of simple Boolean statements. Two types of these statements are conditions and effects.

Conditions are Boolean functions that ask questions about a state of the world. For example, HasItemCountGE (itm_Wood, 100) is true if the actor has at least 100 units of the resource wood.

Effects modify the state of the world to make their expression true. For example, Has ItemCountGE (itm_Wood, 100) can also be an effect, adding 100 wood to the players inventory such that the corresponding condition is true.

Terms can be combined into “programs” with parenthesis, ands, and nots to make diverse sets of logical expressions with relatively few term definitions. A C++ function can be used for evaluating terms and applying effects. The execution of a program to acquire a Boolean result may be handled by a virtual stack machine. Terms may be specified in a custom syntax, and then compiled into programs.

Rather than using an Abstract Syntax Tree, as many other languages, herein all terms can be uniquely identified and stored in a simple array. This array stores the name of the terms, as well as the arguments. Using the term data, multiple passes in the compiler can be performed to allow variables, which are eventually logically bound during planning. See Logic Binding herein.

### Goals

Goals can be defined with seek conditions, and satisfaction conditions. Seek conditions are the conditions under which an agent should pursue a goal, while satisfaction conditions are the conditions which satisfy the goal. In the Code Example 3 of the Appendix, the agent will attempt to acquire 100 wood, but only if the actor controls a mill that produces wood.

### Methods

Methods can have preconditions and sub-goals. Preconditions are conditions under which an agent will use a method to refine a goal for which the method is relevant. Relevance can be determined by the last sub-goal in the list of sub-goals, where the sub-goals list is read as a checklist of tasks to be accomplished.

In Code Example 4 of the Appendix, the method is relevant to the goal of Has ItemCountGE (itm_Wood, OneHundred) because its last sub-goal is applicable to Has ItemCountGE. However, the method would only be used if the preconditions are satisfied, in this case that the agent does not already have a lumbermill. The list of sub-goals guides the agent to first acquire space to build the lumber mill, then get the required supplies, then to build the lumbermill, then to get wood (implicitly by using the lumbermill, though this is not required).

### Actions

Actions are the most complex of the refiners because they must handle time. Actions may have several sets of terms which drive their behavior, such as preconditions, durative conditions, start effects, and end effects. An action may further have an action class, which dictates the duration of an action based on the current State. See Code Example 5 of the Appendix.

The durative conditions of the action of Code Example 5 indicate that for the entire time that we are using a lumber mill to get wood, the lumbermill must exist, this tells us that the action fails if the lumbermill is destroyed before all of the wood gets harvested.

The precondition indicates that the lumbermill must be available, e.g., that it is not being repaired, and that it is not in use to produce wood before the action starts.

This concludes the conditions portion of the action, the effects portion contains the same terms as the conditions portion, but the terms are interpreted as effects, rather than conditions.

The start effects of the action apply immediately upon starting the action, while end effects occur once the duration of the action has elapsed. For simplicity, the system can optionally be arranged so that no effect occurs between the start and the end of the action. In this example, the start effect makes the lumbermill unavailable, because we are now using it for harvesting wood. The end effect makes the lumbermill available again, because we have finished using it for harvesting wood.

### State Representation

A state is a collection of named values associated with objects and/or sets of objects at a point in time. Each type of object has a finite set of unique members at any point in time.

Some object type sets are static, while others are dynamic. Static type sets are fixed from one phase of activity to another. For example, in the case that the world is a game, static types may be fixed during the lifetime of an actor's character in the game, e.g., from the start of a game to the end of a game. Examples of type sets in this category are Items. For example, players may be informed of all possible items in the game when the game starts.

Dynamic types are not fixed from one phase of activity to another. For example, in the case of a game, members of dynamic type sets may be added or destroyed on each turn. Members of dynamic type sets can be created by the agent, for example, in accordance with the successful execution of actions. Similarly, dynamic type sets can be used where there are potentially too many members of that typeset to include practically.

Multiple agents can operate on behalf of multiple actors for a single world. It can be preferable to share static type sets among all agents, while dynamic type sets are unique per agent. For instance, in a game where two actors vie for use of common resources in the world, the two agents of the actors can share the same definitions for what certain Items there are in the game (e.g., parcels of land), but have distinct sets of buildings or territory in the game, where each agent only knows about the buildings that they can see, e.g., what is owned by the actor or visible from what is owned by the actor.

The distinction between static and dynamic types helps to alleviate many of the problems imposed by having multiple agents by uncoupling, where practical, disjoint sets of state variables. This way, when two agents act simultaneously, they do not have to coordinate regarding entities that are independent in the world. This minimizes the need for coordination and/or resolution of interference.

For efficiency, it is preferable for static type definitions to be shared among all agents in a world for easy communication of the State of the world. At the same time, if all agents refer to itm_Apple by the same name, it is important to keep the counts of apple in each agent's inventory, as well as that agent's affinity for apples, distinct per agent.

There is no rigid constraint on how a State is represented. For example, conditions and effects may be implemented by C++ functions, which enable storing a State in whatever format is the most efficient in terms of memory layout, rather than being forced into some standard data structure.

In addition to State Variables, quantities associated with members of typesets that can change, e.g. the count of apples in an agent's inventory, there are state constants. State constants are values that do not change over the course of an agent's lifetime, and they encode information about the world that cannot change, sometime called “rigid relations” in the literature. These constants are stored outside of the rest of the state with dynamic quantities, allowing us to shrink the total size of the state. For example, recipes for certain actions, such as crafting items in game or performing tasks in a factory may be defined by such constants.

### Logic Binding Language

In our previous examples of refiners we have referred to items and buildings by name. This is rarely done in the interface because doing so would require users to specify actions for each instance of a Resource. This is expected for AI planners generally because of the need to determine which AI actions are relevant to which goals.

### Relevance Checking

To facilitate refining and eventually solving goals automatically, relevance can be checked at a term level. For example, terms may be checked for relevance declarations, matching of ident arguments, and matching of variable types.

Code Example 6 of the Appendix is a relevance declaration table Examples 6a-6c used for checking relevance in Examples 6d-6g. The terms HasItemCount and HasBuilding are declared as relevant to themselves, and Increase ItemCount declared as relevant to HasItemCount.

In Example 6d, the terms are defined to be relevant to each other in 6a. Further, in 6d the ident arguments match, with same item name itm_Wood. The terms are relevant.

All of the ident arguments may be checked, such that that each ident argument of term A matches each ident argument of term B up to the first non-ident argument of term B, or until the term B is out of arguments.

In Example 6e, while the two terms are defined to be relevant to each other in 6a, the ident arguments do not match. The ident arguments are different item names. In the world of this example, the amount of stone gotten is not relevant to the amount of wood gotten. Therefore the terms are not relevant.

In Example 6f, that the terms are defined to be relevant to each other in 6b. Further the terms have matching ident arguments. However, the two terms have different numbers of arguments. But this need not matter. Permitting non-matching numbers of arguments—provided other checks are met—allows great flexibility in evaluating the relevance of terms. For example, this allows term definitions to have less information than the goals they are trying to solve. This is an important relaxation from traditional relevance definition practices and allows for flexibility during Binding.

In Example 6g, the two terms are not defined to be relevant to each other. Therefore they are not relevant regardless of their arguments. Even if the ident arguments did match, the terms would not be relevant.

The processing of term relevance may be facilitated by using concrete Types for variables, whereby the Type is used for relevance in the absence of a concrete identifier. In Code Example 7 of the Appendix, the term HasItemCount (A, B) A can have the type Item, while B has type Item_Amount. The Type of a variable defines the set of values that it is allowed to take on. For instance, variables of Type Item can be allowed to be any item, while Item_Amount can be allowed to be one of a defined set of named numeric values, one of which is One.

The use of Types allows relevance checks to be performed even when a term contains one or more Variables. In the examples, the final check Condition under which a term can be relevant to another is if the terms are declared relevant to each other, the arguments match if they are specified, or else they are variables.

### Relevance Bindings

Relevance checks are the first part of the binding process. Two terms can “relevance bind” to each other if they are defined to be relevant in the dictionary of refiners. In Code Example 8 of the Appendix, relevance further requires that one of the two terms has a variable argument in the correct position.

In Code Example 8, the variable argument in Increase ItemCount is replaced with the corresponding variable from Has ItemCount, but Ten is unchanged, because it is not a variable.

This is the heart of the reusability of the logic binding language: we can create a single action to increase the count of an item, and it will apply to all goals of that kind.

### Applicability Binding

Applicability binding can be performed in tandem with relevance binding, e.g., as a second binding pass, or on its own. Traditionally, refiners are “applicable” if their preconditions are satisfied in a particular state. This works, for example, for preconditions with variables in them to determine if they are satisfied.

However, more generally we use applicability binding can be performed on any set of conditions with variables, not just preconditions. This can be done, for example, by performing an NP-Hard circuit satisfaction search over all variables in the conditions to find a set of assignments to variables which makes the condition true. The performance challenges of this approach can be addressed in a number of ways. The search can be performed iteratively, and a cap may be set on the total number of iterations undertaken. Further, complexity can be reduced by disallowing OR operators inside of Condition expressions which undergo binding. This means that every term added to the Condition will shrink the set sizes of the variables in question, making the search space smaller.

Taken together, the use of capped iterations and disallowing OR operators has the effect that the binding search time is always bounded in a controllable way, and that the effectiveness of the binding process can only be improved by adding more information to the conditions. Further efficiency can be achieved by limiting the number of arguments permitted per term. For example, terms may be limited to having up to three arguments. The more arguments, the more complexity in the binding search, resulting in more binding search time.

Applicability binding allows efficient expression of an actor's desires in a Strategy made up of high-level, general goals. In Code Example 9 of the Appendix, a goal is expressed statically. The goal reads, in effect, “Start a war with someone that does not have formidable strength, and with whom I do not have an alliance.” But the search for which “someone” A—e.g., another actor or nation in a game world—would occur at runtime. The actor sets the high-level goal. The agent refines the goal, e.g., using relevance and applicability binding, and selects the enemy using a binding search.

### Refiner Tree

FIG. 2 illustrates an example refiner tree. The refiner tree is a tree of methods and actions which are connected by their relevance to goals. Static definitions can be used, e.g., in an actor interface, in building the refiner tree. This reduces the number of Relevance checks required during planning, e.g., in the transition from linear time in the size of the refiner space, to constant time in a phase of activity.

### Planning

Planning and scheduling can be conducted separately or in concert or coordination with each other.

A Planner can be implemented as an algorithm using iterative depth first search over the contents of one or more refiner Trees. For each Refiner Tree, a goal is introduced as the root of the tree. Refiners relevance bind the bound values in the root of the goal. For further efficiency, an Applicability binding can be done over the preconditions of the Refiner Tree. When an Applicability Binding succeeds, the associated Refiner is applied. actions update the State being refined, methods update the goal in a stack wise fashion, pushing goals onto the stack ahead of the root goal. Then the process repeats, until all goals are satisfied.

### Numeric Feedback Control System

A Numeric Control System can be used by the agent feedback system is the largest change from traditional AI planners, it converts the system from an-open loop control system to a closed-loop control system, where deviations from expected parameters are handled each turn by, e.g., a bank of proportional-integral-derivative (PID) controllers, there is one PID controller per essential number in the plan. Each controller is responsible for maintaining the value of that critical number, as dictated by the needs of the plan.

Once a plan is made, the preconditions of all actions are scanned, and each one that requires an essential number to be at a particular level is added to the PID controller list.

Each turn the PID controllers run, this means that the set-target value of the essential value is compared against the true value read from the world. The difference of these two numbers is the Error. PID controllers are nothing but a function of the error, called in a feedback loop. The function is:

$$P * Error + I * \int Error + D * Δ Error$$

Here P, I, and D are scalar constants that can be tuned per essential number, the Integral of the error is the total error from the beginning of time until now, and the derivative of the error is the rate of change of the error.

The result of this function is known as the system response, it is the correction that must be made to drive the error to zero. The system responses in our case are converted into goals. If these goals are solvable in a manner that does not invalidate the existing plan, then the plan to correct the error is appended to the front of the existing plan. However, if correcting the error invalidates the current plan, then the original plan is discarded, the correction goal is added to the agents' goal list, and a new plan is made from scratch.

### GENERAL APPLICABILITY

The artificial intelligence planning, scheduling, and execution techniques described herein, e.g., in reference to FIGS. 1-12, in reference to the code examples of the Appendix, and or in the claims, may be used separately or in any combination and may take advantage of any of the optional features described herein. The techniques may be used in a variety of contexts such as: computer games; training simulations; research simulations, such as in scientific, economic, military, logistical, and other inquiries and prognostication; commercial, industrial, and agricultural operations; and robotics.

The techniques are generally beneficial in contexts where timely autonomous operations and/or efficient use of computing resources are required, and the environment is sufficiently modeled as described herein. This can include, e.g., gaming and simulation environments with inputs and/or participating actors distributed across a network. This can additionally or alternatively include fully or semi-autonomous systems, such as deployed vehicles and/or scientific, commercial, industrial, agricultural, or military equipment which, having received a strategy, a planning and scheduling language, and sufficient information regarding an initial state of the world, may proceed to form plans, schedule activities, and execute actions adaptively in view of the original state, the original strategy, sensory input, and communicated updates.

### APPENDIX

### Code Example 1

ident=<letter>{<letter>|<digit>}
number=<digit>{<digit>}[<digit>{<digit>}]
argument=ident|number
term=ident [‘(’[argument {, argument}]‘)’]
unaryexpr={“not” }(term | ‘(’ andexpr ‘)’)
orexpr=unaryexpr {“or” unaryexpr}
andexpr=orexpr {“and” orexpr}
predicate=andexpr

### Code Example 2

### Predicates

not HasItemCountGE(itm_wood, OneHundred) and HasBuilding(LumberMill, One)
HasSpaceForBuilding(LumberMill, One)
not BuildingIsAvailable (LumberMill, One)

### Code Example 3

### Goal Terms

SeekCondition: not HasItemCountGE(itm_wood, OneHundred) and HasBuilding(LumberMill, One)
SatCondition: HasItemCountGE(itm_Wood, OneHundred)

### Code Example 4

### Method Terms

PreCondition: not HasBuilding (LumberMill, One)
Subgoals: HasSpaceForBuilding(LumberMill, One), HasSuppliesForBuilding (LumberMill, One) HasBuilding(LumberMill, One)
HasItemCountGE (itm_Wood, OneHundred)

### Code Example 5

### Action Terms

ActionClass:CutWoodAtLumberMill
DurativeConditions: HasBuilding(LumberMill, One)
PreConditions: BuildingIsAvailable (LumberMill, One)
StartEffects: not BuildingIsAvailable (LumberMill, One)
EndEffects: HasItemCountGE(itm_Wood, 100) and BuildingIsAvailable (LumberMill, One)

### Code Example 6

### Relevance Checking

| | relevance definition table: | |
|---|---|---|
| (6a) | HasItemCount −> HasItemCount | |
| (6b) | IncreaseItemCount −> HasItemCount | |
| (6c) | HasBuilding −> HasBuilding | |
| | refiner term: | relevance: |
| | goal term: | |
| (6d) | HasItemCount(itm_Wood, Ten) | relevant to |
| | HasItemCount(itm_Wood, Thirty) | |
| (6e) | HasItemCount(itm_Stone, Five) | NOT relevant to |
| | HasItemCount(itm_Wood, Five) | |
| (6f) | IncreaseItemCount(item_Wood) | relevant to |
| | HasItemCount(itm_Wood, Ten) | |
| (6g) | HasBuilding(Forge) | NOT relevant to |

HasItemCount(itm_Stone, Fifty)

### Code Example 7

### Relevance and Variable Type

HasItemCount(A, B)

### Code Example 8

### Relevance Binding

IncreaseItemCount(A, Ten) binds to HasItemCountGE(Wood, Five)→IncreaseItemCount(Wood, Ten)

### Code Example 9

### Applicability Binding

Conditions: not HasStrength(A, Formidable) and not AgreementActive (Self, A, Alliance)
Goal: AtWar(Self, A)

1. A computer-implemented planning agent comprising, the agent comprising:
a dictionary of refiners, the refiners comprising goals, actions, and methods, wherein goals indicate desired values of variables, actions mutate values of variables, and methods decompose higher-level goals into lists of lower-level goals (sub-goals), and wherein the variables pertain to a set of objects describing a simulated world comprising a model of a natural, manmade, or imaginary environment, wherein the dictionary is predefined to express relevance relationships between goals and other refiners that advance those goals, and wherein refiners are expressed in variable types to facilitate rapid automated selection of and type checking of refiners;
a strategy interface providing a strategy comprising a list of priorities expressed as goals in accordance with the dictionary of refiners, the priorities being for a phase of activity that comprises multiple turns, the strategy reflecting interests of a first actor having agency in the simulated world;
an initial state of the environment, wherein a state comprises values of variables of objects of the environment, and wherein the initial state is at a point in time at a beginning of the phase of activity;
a planner which, starting from the strategy and the initial state of the environment, uses one or more of the refiners to create a plan by building a tree of actions, methods, and/or lower-level goals (sub-goals) descending from one or more goals of the strategy, via automated refiner selection and type checking;
a scheduler which creates a schedule for the implementation of actions of the plan, accounting for streams of actions that may be executed in parallel when possible; and
a controller which, in step with real-time passage of turns in the world through the phase of activity, executes the schedule by implementing actions to an extent permitted by a state of the environment at each turn,
wherein:
the planner does not account for specific turns in which actions may be executed;
the scheduler does not operate until the plan is completed by the planner.

2. The agent of claim 1, wherein the planner builds the tree iteratively by, in each iteration:
first binding relevant refiners to distal nodes of the tree, wherein the relevant refiners for each distal node are refiners that are defined, in the dictionary of refiners, to be relevant to the distal node;
next binding those relevant refiners that are applicable, wherein the applicable refiners are those which are supported in accordance with accumulated conditions of the distal node in view of pertinent values of variables of the environment in a proposed state of the distal node, wherein the proposed state is the initial state of the environment as permuted by actions occurring along a branching of the tree leading to the distal node; and
rejecting relevant refiners that are not applicable.

3. The agent of claim 2, wherein the planner builds the tree by pushing refiners onto a stack ahead of a goal of the strategy.

4. The agent of claim 3, wherein the initial state of the environment is limited to values of variables of objects are selected from a complete state of the world, wherein the objects are those objects which, under rules of the world, the first actor is permitted to observe.

5. The agent of claim 4, wherein the objects are those objects under the control of the first actor.

6. The agent of claim 5, wherein the controller is configured to first detect a deviation from expected execution times for scheduled actions, then check whether, in view of the deviations, the schedule may still be accommodated within windows of opportunity of the schedule, and if the schedule may not still be accommodated, seek corrective action by:
attempt to relevance bind and applicability bind a first new action at a first current state, the first current state being at the time in the schedule at the deviation from expected times occurs;
if the first new action is bound, then if the first new action can be accommodated within windows of opportunity of the schedule, adjust the schedule to incorporate the first new action;
if no first new action is bound, or if the first new action cannot be accommodated within windows of opportunity of the schedule, trigger re-planning by the planner, wherein the planner uses the current state as the initial state.

7. The agent of claim 6, wherein the controller is configured:
to a detect deviation from expected resource values for scheduled actions,
attempt to relevance bind and applicability bind a second new action in a second current state of the environment, the second current state being at the time in the schedule where the deviation from expected resource values occurs;
if the second new action is bound, check whether the second new action may be accommodated within windows of opportunity of the schedule and adjust to the schedule to incorporate the new action;
if no second new action is bound, trigger re-planning by the planner, wherein the planner uses the second current state as the initial state.

8. The agent of claim 7, wherein the strategy interface comprises a user interface whereby goals of the strategy are formed via menu selections by a user.

9. The agent of claim 7, wherein the strategy interface comprises a natural language interface wherein the goals of the strategy are determined using one or more natural language descriptions provided by a user.

10. The agent of claim 9 wherein the controller is configured to introduce randomness to schedule execution by one or more of causing actions to: fail; provide diminished resource effects; be delayed in starting; or be delayed in concluding.

11. The agent of claim of claim 10, further comprising a refiner development interface whereby a user may add one or more new refiners to the dictionary.

12. The agent of claim 1, wherein the world is a game and the first actor is a human player of the game.

13. The agent of claim 1, wherein the world is an industrial environment.

14. The agent of claim of claim 11, wherein the world is a biosphere.

15. A computer game for multiple human players, the game being a competitive strategy game with each player operating one or more characters, the game comprising, for one or more of the characters, an instance of the agent of claim 14, wherein, for each character with an agent, the player associated with the character provides a strategy, via the strategy interface, for each phase of activity.

16. The game of claim 15, wherein the game advances with one character at a time tacking actions, during one or more turns of a phase of activity.

17. The game of claim 15, wherein game advances in a sequence of phases of activity, wherein in each phase of activity cycle, a course of action for each character is attempted to be executed simultaneously.

18. The game of claim 17, further comprising a non-player character, the non-player character being implemented by a further instance of the agent of claim 1 using a strategy scripted by a character developer.

19. A computer game for multiple human players, the game being a competitive strategy game with each player operating one or more characters, the game comprising a non-player character, the non-player character being implemented by an instance of the agent of claim 14 using a strategy scripted by a character developer.

20. The game of claim 19, wherein the game advances in a sequence of phases of activity, wherein in each phase of activity, a course of action for each character is attempted to be executed simultaneously.
